(19) United States
(12) Patent Application Publication
(10) Pub. No.: US 2005/0104362 A1
(43) Pub. Date: May 19, 2005

(54) Book cover with laced spine

(75) Inventor: Raymond Kam, New Territories (CN)

Correspondence Address: ALIX YALE & RISTAS LLP, 750 MAIN STREET, SUITE 1400, HARTFORD, CT, 06103, US

(73) Assignee: Rackel Industries Limited

(21) Appl. No.: 10/712,738

(22) Filed: Nov. 13, 2003

(51) Int. Cl. B42D 3/00

(52) U.S. Cl. 281/29

(57) ABSTRACT

A book cover has a front plate having a hinge at one edge and a pocket for receiving a front page of a book or front sheet of a multi-page insert. The cover also includes a back plate having a hinge at one edge and a pocket for receiving a back page of a book or back sheet of a multi-page insert. A laced spine interconnects the hinges to enable expansion and contraction as desired to accommodate the overall thickness of a book's pages and any cuttings or inserts that might later be attached to the pages.

### BACKGROUND OF THE INVENTION

The present invention relates to book covers. More particularly, although not exclusively, the invention relates to a detachable book cover having a laced spine connecting it's front and rear plates so that book inserts of varied thickness can be accommodated.

It is known to provide removable book covers for diaries and photo albums for example. Such covers have a spine of fixed size to accommodate a book or page-insert of predefined thickness. Where loose sheets or an excessive number of photographs for example are adhered to the pages of such books, the spine can be of inadequate width to properly accommodate the combined thickness of the pages and photographs for example. This problem might be particularly prevalent in scrapbooks for example where it is desired to stick samples or cuttings for example upon pages of the scrapbook.

### OBJECTS OF THE INVENTION

It is an object of the present invention to overcome or substantially ameliorate the above disadvantages and/or more generally to provide a book cover with a laced spine that can be expanded and contracted as desired to accommodate the overall thickness of a book's pages and any cuttings or inserts thereon.

### DISCLOSURE OF THE INVENTION

There is disclosed herein a book cover comprising:
a front plate,
a back plate having a pocket for receiving a back page of a book or back sheet of a multi-page insert, and
a lace interconnecting the plates.

Preferably the front and back plates each have a hinge at one edge.

Preferably the front plate has a pocket for receiving a front page of a book or front sheet of a multi-page insert.

Preferably the book cover further comprises a pair of apertured strips—one at an edge of each of the front and back plates.

Preferably, the book cover further comprises flexible strips connecting the apertured strips to the front and back plates respectively.

Preferably the flexible strips are elastic.

Preferably the lace passes through the apertures of the apertured strips to connect the apertured strips together.

The lace might be non-stretchable, or elastic.

### BRIEF DESCRIPTION OF THE DRAWINGS

Preferred forms of the present invention will now be described by way of example with reference to the accompanying drawings, wherein:

FIG. 1 is a schematic perspective illustration of a book cover having a book inserted therein,

FIG. 2 is a schematic perspective illustration of individual components of the book cover,

FIG. 3 is an illustration showing how the front or back cover of a book or page insert is slid into a pocket at either the front or back plate of the book cover, and

FIG. 4 is a schematic perspective illustration of another book cover.

### DESCRIPTION OF THE PREFERRED EMBODIMENTS

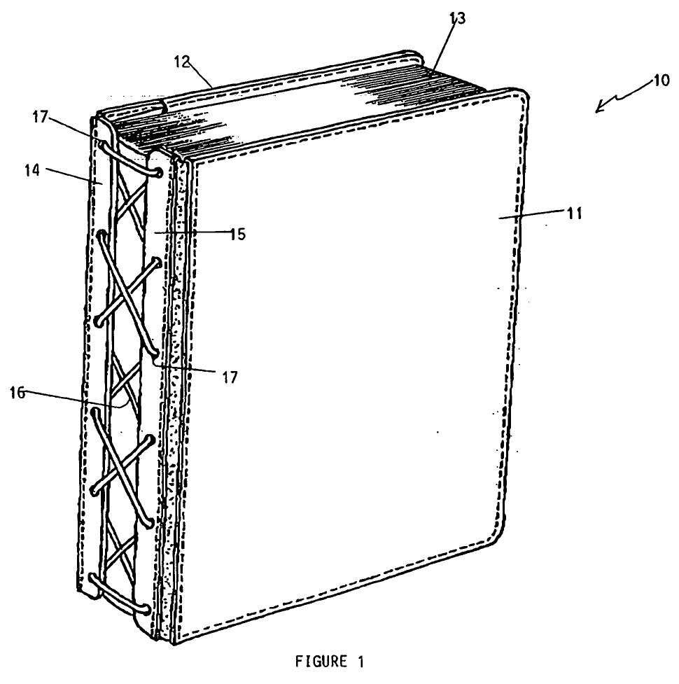

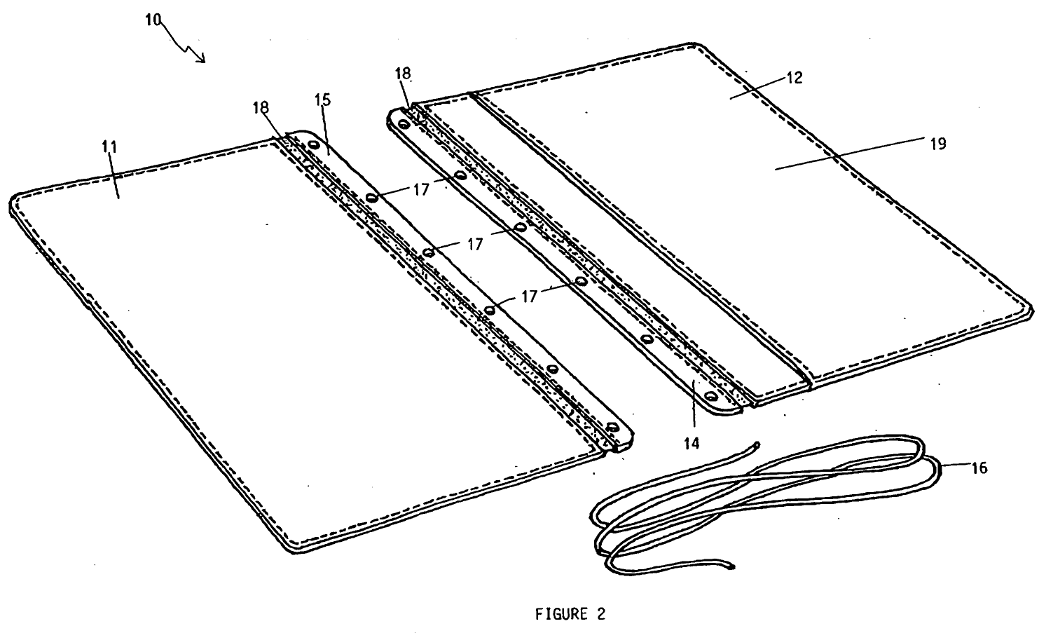

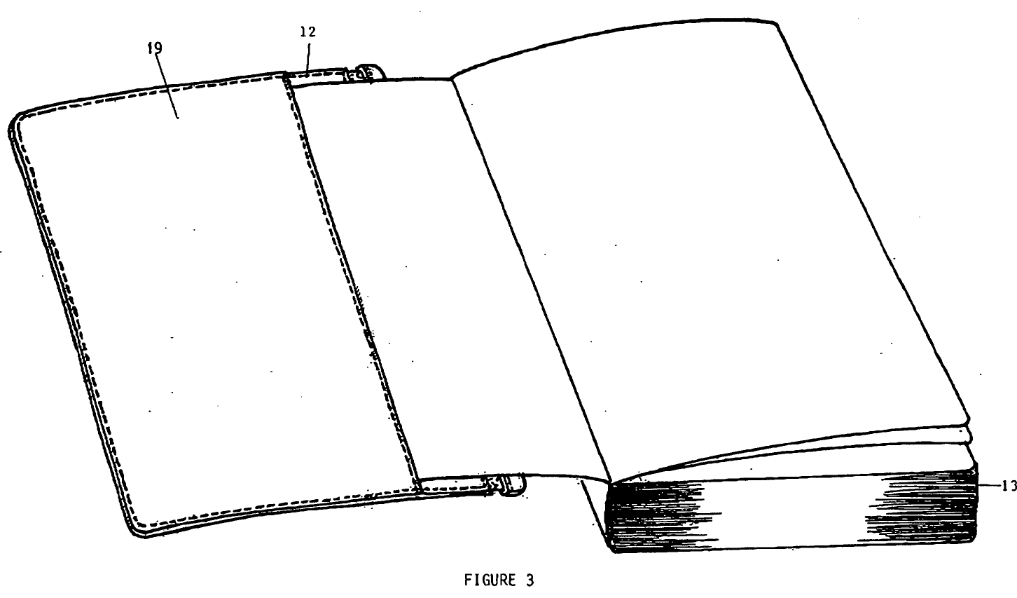

In FIGS. 1 to 3 of the accompanying drawings there is depicted schematically a book cover 10. Book cover 10 comprises a front plate 11 and a back plate 12 between which a book including pages 13 is located. The back cover 12 has a pocket 19 for receiving the back cover of the book (typically a paperback book having a soft cover). The front cover 11 might optionally be provided with a similar pocket although such is not shown in the drawings.

Both the front and back covers have flexible strips 18 along one edge to which apertured strips 14 and 15 are secured. The flexible strips 18 would typically be made of elastic or other flexible material, whereas the front and back plates would typically be made of leather-covered cardboard for example. Stitching secures the flexible strips 18 and apertured strips 14 and 15 together, whereas stitching is also used to seam the front and back plates about their cardboard inserts. Adhesive or plastics welding for example might be used—depending on the choice of materials.

The apertured strips 14 and 15 each comprise a plurality of spaced-apart apertures 17 through which a lace 16 extends. The lace 16 might be a flexible non-stretching shoelace or an elastic lace. If a non-stretchable shoelace were chosen and the flexible strips 18 made of elastic, the flexible strips would provide a degree of expansion sufficient to accommodate books of a certain thickness range, without the need to re-tie the lace. If an elastic lace is chosen, the flexible strips 18 need not be elastic, although additional expansion of the spine would be provided if they were.

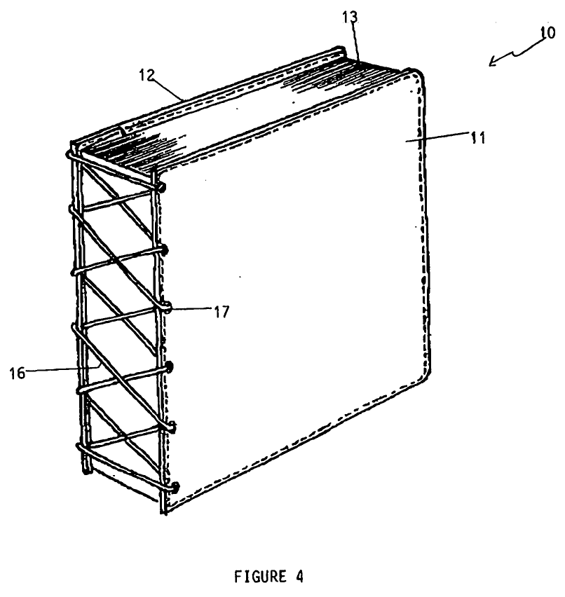

An alternative embodiment is depicted in FIG. 4. In this embodiment, components 14, 15 and 18 are dispensed with. Instead, apertures 17 are provided along a strip directly at the edge of each of the front and back plates of the book cover. A lace 16 directly connects the front and back plates together.

In use, the back cover of a paperback book or page insert 13 is slid into the pocket 19 of the back plate. If a pocket is provided at the inside of the front plate 11, the front cover of the book or page insert can be slid into it as well. If the book is to be used as a scrapbook or photo album for example, the insertion of photographs or cuttings will increase the overall thickness of the pages and the spine comprising the hinges of apertured strips and flexible strips and lacing will expand to accommodate this. On the other hand, if non-stretching shoelace and a non-elastic set of strips 18 are adopted, then the lace 16 can be untied and fed through the apertures 17 and tied up again.

It should be appreciated that modifications and alterations obvious to those skilled in the art shall not be considered as beyond the scope of the present invention. For example, the lace 16 might be replaced by another flexible strip of elastic extending between the strips 14 and 15 which in this case need not the apertured.

1. (canceled)

2. The book cover of claim 5 wherein the front and back plates each have a hinge at one edge.

3. The book cover of claim 5 wherein the front plate has a pocket for receiving a front page of a book or front sheet of a multi-page insert.

4. The book cover of claim 5, further comprising a pair of apertured strips one at an edge of each of the front and back plates.

5. A book cover comprising:
a front plate,
a back plate having a pocket for receiving a back page of a book or back sheet of a multi-page insert, and a lace interconnecting the plates, and
said book cover further comprising a pair of apertured strips one at an edge of each of the front and back plates and flexible strips connecting the apertured strips to the front and back plates respectively.

6. The book cover of claim 5 wherein the flexible strips are elastic.

7. The book cover of claim 5 wherein the lace passes through the apertures of the apertured strips to connect the apertured strips together.

8. The book cover of claim 7 wherein the lace is elastic.
